(19) United States
(12) Patent Application Publication
(10) Pub. No.: US 2024/0418688 A1
(43) Pub. Date: Dec. 19, 2024

(54) POWER SUPPLY METHOD FOR INTRINSICALLY-SAFE GAS CHROMATOGRAPH

(71) Applicant: CCTEG SHENYANG RESEARCH INSTITUTE, Fushun (CN)

(72) Inventors: Junjie ZHANG, Fushun (CN); Yuntao LIANG, Fushun (CN); Jie REN, Fushun (CN); Yong SUN, Fushun (CN); Gang WANG, Fushun (CN); Xuewei GE, Fushun (CN); Dong ZHANG, Fushun (CN); Chengao FU, Fushun (CN); Jilin CUI, Fushun (CN); Honghao HE, Fushun (CN); Yuting ZHENG, Fushun (CN); Xuanliang WANG, Fushun (CN)

(21) Appl. No.: 18/815,141

(22) Filed: Aug. 26, 2024

Related U.S. Application Data
(63) Continuation of application No. PCT/CN2023/086434, filed on Apr. 6, 2023.

(30) Foreign Application Priority Data
Aug. 26, 2022 (CN) 202211038565.X

(51) Int. Cl. G01N 30/88; G01N 30/02

(52) U.S. Cl. CPC G01N 30/88; G01N 2030/025

(57) ABSTRACT

Disclosed is a power supply method for an intrinsically-safe gas chromatograph. The power supply method includes: converting an original single-circuit power supply mode in a gas chromatograph into a multi-circuit power supply mode, so as to respectively supply power for a temperature control circuit, a pressure control circuit, a signal acquisition circuit, a communication circuit, a heating wire, an air extracting pump, a solenoid valve and a proportional solenoid valve in the gas chromatograph, wherein power supplies in the multi-circuit power supply mode of the gas chromatograph are all independent power supplies, and are not associated with each other; the number of the power supplies of the multi-circuit power supply mode is greater than or equal to 2; each power supply in the multi-circuit power supply mode is a direct-current power supply, and the voltage of each direct-current power supply is DC5V-DC36V; and the temperature control circuit, the pressure control circuit, the signal acquisition circuit, the communication circuit, the heating wire, the air extracting pump, the solenoid valve and the proportional solenoid valve in the gas chromatograph are combined in different modes, and are correspondingly powered by a plurality of power supply circuits; and an output current of the independent power supply is less than or equal to 3 A.

### TECHNICAL FIELD

The present disclosure belongs to the technical field of application of a gas chromatograph, and specifically relates to a power supply method for an intrinsically-safe gas chromatograph.

### BACKGROUND OF THE INVENTION

Gas chromatography has been developed for more than 50 years, and now has become a mature and widely used analysis technology for separating complex mixtures, has been widely used in the fields such as petrochemical analysis, drug analysis, food analysis, environmental analysis, and polymer analysis, and is an important tool in industry, agriculture, national defense, construction, and scientific research. Explosion-proof gas chromatographs are used in some dangerous places, such as oil exploitation monitoring, chemical production process monitoring and coal mine underground monitoring; and since the housing of the explosion-proof gas chromatograph is subjected to an explosion-proof design, the gas chromatograph can be used in some specific dangerous places.

The gas chromatograph analyzes a gas sample by injecting a gas with explosive hazards into the inside of an explosion-proof chamber. Since there are various functional electronic circuit apparatuses in the explosion-proof chamber, the spark energy of circuits is still capable of igniting these dangerous gases, causing an explosion, such that such explosion-proof gas chromatograph only solves the problem that the gas chromatograph does not affect the external environment within a limited number of explosions and a certain explosion equivalent range, but does not fundamentally solve the safety problem of the gas chromatograph. Once a leak occurs, energy sparks causing an explosion still exist in the circuits inside the gas chromatograph, which still has certain safety hazards.

The main reason of a dangerous gas explosion caused by the sparks generated by the circuits in the explosion-proof chamber is that, various functional circuits and components in the explosion-proof chamber in the current gas chromatograph all use a single-circuit power supply mode, resulting in excessively high energy stored inside the circuits in the explosion-proof chamber of the gas chromatograph, thus generating sparks, resulting in an explosion. Therefore, it is necessary to improve a power supply mode inside the gas chromatograph, so as to fundamentally solve the safety problem of the gas chromatograph.

### SUMMARY OF THE INVENTION

In view of the above problem, and in order to make up deficiencies in the prior art, the present disclosure provides a power supply method for an intrinsically-safe explosion-proof gas chromatograph.

In order to implement the above objective, the present disclosure uses the following technical solutions.

The present disclosure provides a power supply method for an intrinsically-safe gas chromatograph. The power supply method specifically includes: converting an original single-circuit power supply mode in a gas chromatograph into a multi-circuit power supply mode, so as to respectively supply power for a temperature control circuit, a pressure control circuit, a signal acquisition circuit, a communication circuit, a heating wire, an air extracting pump, a solenoid valve and a proportional solenoid valve in the gas chromatograph. Power supplies in the multi-circuit power supply mode of the gas chromatograph are all independent power supplies, and are not associated with each other; the number of the power supplies of the multi-circuit power supply mode is greater than or equal to 2; each power supply in the multi-circuit power supply mode is a direct-current power supply, and the voltage of each direct-current power supply is DC5V-DC36V; and the temperature control circuit, the pressure control circuit, the signal acquisition circuit, the communication circuit, the heating wire, the air extracting pump, the solenoid valve and the proportional solenoid valve in the gas chromatograph are combined in different modes, and are correspondingly powered by a plurality of power supply circuits; and an output current of the independent power supply is less than or equal to 3 A.

As a preferred solution of the present disclosure, there are 3 power supply circuits of the multi-circuit power supply mode, respectively being a number one power supply circuit, a number two power supply circuit and a number three power supply circuit. The number one power supply circuit, the number two power supply circuit and the number three power supply circuit correspondingly supply power for the temperature control circuit, the pressure control circuit, the signal acquisition circuit, the communication circuit, the heating wire, the air extracting pump, the solenoid valve and the proportional solenoid valve in the gas chromatograph, which are combined in different modes. The temperature control circuit, the pressure control circuit, the signal acquisition circuit, the communication circuit, the heating wire, the air extracting pump, the solenoid valve and the proportional solenoid valve in the gas chromatograph are combined in parallel or in series in different modes.

As another preferred solution of the present disclosure, the number one power supply circuit is connected to the temperature control circuit, the pressure control circuit and the signal acquisition circuit, and supplies power for the temperature control circuit, the pressure control circuit and the signal acquisition circuit; the number two power supply circuit is connected to the communication circuit, the proportional solenoid valve, the air extracting pump and the solenoid valve, and supplies power for the communication circuit, the proportional solenoid valve, the air extracting pump and the solenoid valve; and the number three power supply circuit is connected to the heating wire, and supplies power for the heating wire.

As another preferred solution of the present disclosure, alternatively, the number one power supply circuit is connected to the temperature control circuit, the pressure control circuit and the proportional solenoid valve, and supplies power for the temperature control circuit, the pressure control circuit and the proportional solenoid valve; the number two power supply circuit is connected to the communication circuit, the air extracting pump and the signal acquisition circuit, and supplies power for the communication circuit, the air extracting pump and the signal acquisition circuit; and the number three power supply circuit is connected to the heating wire and the solenoid valve, and supplies power for the heating wire and the solenoid valve.

As another preferred solution of the present disclosure, the number one power supply circuit includes a direct-current 12V power supply, a field effect transistor M1, a first single-chip microcomputer, and a triode Q1. An output end of the direct-current 12V power supply is connected to a drain D of the field effect transistor M1, and a source S of the field effect transistor M1 is connected to a resistor R62 and a diode D1. The source S of the field effect transistor M1 is connected to a cathode of the diode D1, and an anode of the diode D1 is connected to a resistor R60. The resistor R60 is connected to a resistor R63. The other end of the resistor R63 is grounded. The other end of the resistor R62 is connected to a collector of the triode Q1 and a gate G of the field effect transistor M1. A base of the triode Q1 is connected to a resistor R1, and the other end of the resistor R1 is connected to a resistor R2. The other end of the resistor R2 and an emitter of the triode Q1 are connected and jointly grounded. An SYS1 signal input end of the first single-chip microcomputer is connected to the anode of the diode D1, and the resistor R60. An IN SYS1 input end of the first single-chip microcomputer is connected to the resistor R60 and the resistor R63, and an OUT SYS1 output end of the first single-chip microcomputer is connected to the resistor R1 and the resistor R2. A control signal output end of the first single-chip microcomputer is correspondingly connected to any one or a combination of more of the temperature control circuit, the pressure control circuit, the signal acquisition circuit, the communication circuit, the heating wire, the air extracting pump, the solenoid valve and the proportional solenoid valve in the gas chromatograph.

As another preferred solution of the present disclosure, the number two power supply circuit has the same circuit structure as the number one power supply circuit.

As another preferred solution of the present disclosure, the number three power supply circuit includes a direct-current 12V power supply, a direct-current 3.3V power supply, a field effect transistor M3, a third single-chip microcomputer, a triode Q3, and a photocoupler U1. An output end of the direct-current 12V power supply is connected to a drain D of the field effect transistor M3, and a source S of the field effect transistor M3 is connected to a resistor R64 and a diode D3. The source S of the field effect transistor M1 is connected to a cathode of the diode D3, and an anode of the diode D3 is connected to a resistor R62. The resistor R62 is connected to a resistor R65. The other end of the resistor R65 is grounded. The other end of the resistor R64 is connected to a collector of the triode Q3 and a gate G of the field effect transistor M3. The other end of the resistor R64 is further connected to a reverse voltage pick-off diode D4, and the resistor R64 is connected to an anode of the reverse voltage pick-off diode D4. A base of the triode Q3 is connected to a resistor R3, and the other end of the resistor R3 is connected to a resistor R4. The other end of the resistor R4 and an emitter of the triode Q3 are connected and jointly grounded. The direct-current 3.3V power supply is connected to a resistor R61, and the resistor R61 is connected to a diode D5. The resistor R61 is connected to an anode of the diode D5, and a cathode of the diode D5 is connected to a cathode of the reverse voltage pick-off diode D4 and a pin 4 of the photocoupler U1. A pin 3 of the photocoupler U1 is connected to the resistor R4 and the emitter of the triode Q3. A pin 1 and a pin 2 of the photocoupler U1 are respectively connected to a resistor R66 and a resistor R67. An SYS3 signal input end of the third single-chip microcomputer is connected to the anode of the diode D3, and the resistor R62. An IN SYS3 input end of the third single-chip microcomputer is connected to the resistor R62 and the resistor R65, and an OUT SYS3 output end of the third single-chip microcomputer is connected to the resistor R3 and the resistor R4. An OUT KZ2.0 output end of the third single-chip microcomputer is connected to the resistor R66 and the resistor R67. A control signal output end of the third single-chip microcomputer is correspondingly connected to any one or a combination of more of the temperature control circuit, the pressure control circuit, the signal acquisition circuit, the communication circuit, the heating wire, the air extracting pump, the solenoid valve and the proportional solenoid valve in the gas chromatograph.

As another preferred solution of the present disclosure, each power supply in the multi-circuit power supply mode is a battery pack, and the voltage of each battery pack is DC3V-DC18V. Each battery pack is composed of batteries in series or in parallel, and the number of batteries of each battery pack is greater than or equal to 2.

The present disclosure has the following beneficial effects.

By means of changing the original power supply mode of a gas chromatograph, specifically, the original single-circuit power supply mode in gas chromatograph is converted into the multi-circuit power supply mode, and all power supply circuits arranged in the present disclosure may supply power in a plurality of combination modes, such that energy stored inside circuits of the gas chromatograph is reduced, so as to meet an intrinsically-safe requirement specified in the GB3836 explosion-proof standard, thereby fundamentally solving the safety problem of the gas chromatograph in terms of power supply.

### BRIEF DESCRIPTION OF DRAWINGS

FIG. 1 is a schematic structural block diagram I of a power supply method for an intrinsically-safe gas chromatograph according to the present disclosure.

FIG. 2 is a schematic structural block diagram II of a power supply method for an intrinsically-safe gas chromatograph according to the present disclosure.

FIG. 3 is a circuit diagram of a number one power supply circuit of a power supply method for an intrinsically-safe gas chromatograph according to the present disclosure.

FIG. 4 is a circuit diagram of a number three power supply circuit of a power supply method for an intrinsically-safe gas chromatograph according to the present disclosure.

### DETAILED DESCRIPTION OF THE INVENTION

In order to make the technical problems to be solved, technical solutions and advantages of the present disclosure clearer, the present disclosure will be further described below in detail with reference to the drawings and specific implementations. It should be understood that the specific implementations described here are merely used to explain the present disclosure, and are not used to limit the present disclosure.

An embodiment of the present disclosure provides a power supply method for an intrinsically-safe gas chromatograph. The power supply method specifically includes: converting an original single-circuit power supply mode in a gas chromatograph into a multi-circuit power supply mode, so as to respectively supply power for a temperature control circuit, a pressure control circuit, a signal acquisition circuit, a communication circuit, a heating wire, an air extracting pump, a solenoid valve and a proportional solenoid valve in the gas chromatograph. Power supplies in the multi-circuit power supply mode of the gas chromatograph are all independent power supplies, and are not associated with each other; the number of the power supplies of the multi-circuit power supply mode is greater than or equal to 2; each power supply in the multi-circuit power supply mode is a direct-current power supply, and the voltage of each direct-current power supply is DC5V-DC36V; and the temperature control circuit, the pressure control circuit, the signal acquisition circuit, the communication circuit, the heating wire, the air extracting pump, the solenoid valve and the proportional solenoid valve in the gas chromatograph are combined in different modes, and are correspondingly powered by a plurality of power supply circuits; and an output current of the independent power supply is less than or equal to 3 A.

There are 3 power supply circuits of the multi-circuit power supply mode, respectively being a number one power supply circuit, a number two power supply circuit and a number three power supply circuit. The number one power supply circuit, the number two power supply circuit and the number three power supply circuit correspondingly supply power for the temperature control circuit, the pressure control circuit, the signal acquisition circuit, the communication circuit, the heating wire, the air extracting pump, the solenoid valve and the proportional solenoid valve in the gas chromatograph, which are combined in different modes. The temperature control circuit, the pressure control circuit, the signal acquisition circuit, the communication circuit, the heating wire, the air extracting pump, the solenoid valve and the proportional solenoid valve in the gas chromatograph are combined in parallel or in series in different modes.

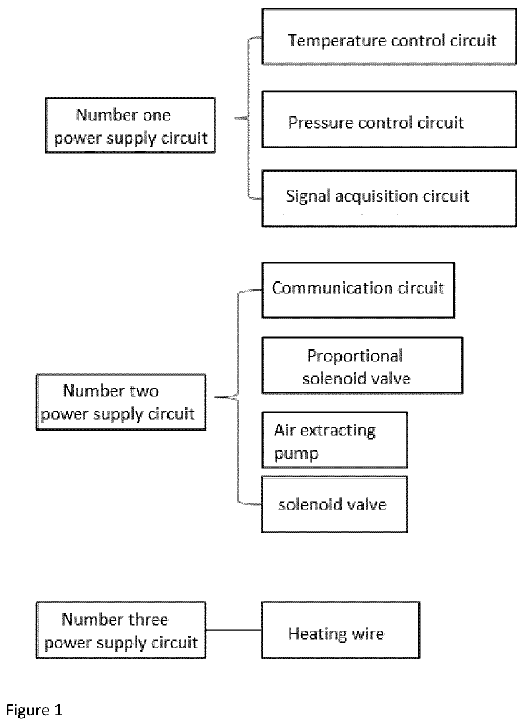

FIG. 1 is a schematic structural block diagram I of a power supply method for an intrinsically-safe gas chromatograph according to the present disclosure. Referring to FIG. 1, it can be learned that, the combination mode among the temperature control circuit, the pressure control circuit, the signal acquisition circuit, the communication circuit, the heating wire, the air extracting pump, the solenoid valve and the proportional solenoid valve is that, the temperature control circuit, the pressure control circuit and the signal acquisition circuit are combined in parallel, and are powered by the number one power supply circuit; the communication circuit, the proportional solenoid valve, the air extracting pump and the solenoid valve are combined in parallel, and are powered by the number two power supply circuit; and the heating wire is powered separately by the number three power supply circuit. Specifically, the number one power supply circuit is connected to the temperature control circuit, the pressure control circuit and the signal acquisition circuit, and supplies power for the temperature control circuit, the pressure control circuit and the signal acquisition circuit; the number two power supply circuit is connected to the communication circuit, the proportional solenoid valve, the air extracting pump and the solenoid valve, and supplies power for the communication circuit, the proportional solenoid valve, the air extracting pump and the solenoid valve; and the number three power supply circuit is connected to the heating wire, and supplies power for the heating wire.

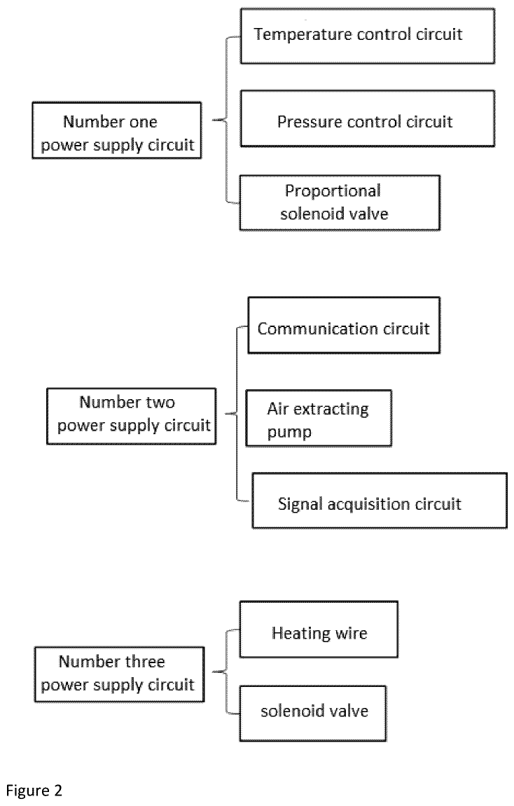

FIG. 2 is a schematic structural block diagram II of a power supply method for an intrinsically-safe gas chromatograph according to the present disclosure. Referring to FIG. 2, it can be learned that, the combination mode among the temperature control circuit, the pressure control circuit, the signal acquisition circuit, the communication circuit, the heating wire, the air extracting pump, the solenoid valve and the proportional solenoid valve is that, the temperature control circuit, the pressure control circuit and the proportional solenoid valve are combined in parallel, and are powered by the number one power supply circuit; the communication circuit, the air extracting pump and the signal acquisition circuit are combined in parallel, and are powered by the number two power supply circuit; and the heating wire and the solenoid valve are combined in parallel, and are powered by the number three power supply circuit. Specifically, the number one power supply circuit is connected to the temperature control circuit, the pressure control circuit and the proportional solenoid valve, and supplies power for the temperature control circuit, the pressure control circuit and the proportional solenoid valve; the number two power supply circuit is connected to the communication circuit, the air extracting pump and the signal acquisition circuit, and supplies power for the communication circuit, the air extracting pump and the signal acquisition circuit; and the number three power supply circuit is connected to the heating wire and the solenoid valve, and supplies power for the heating wire and the solenoid valve.

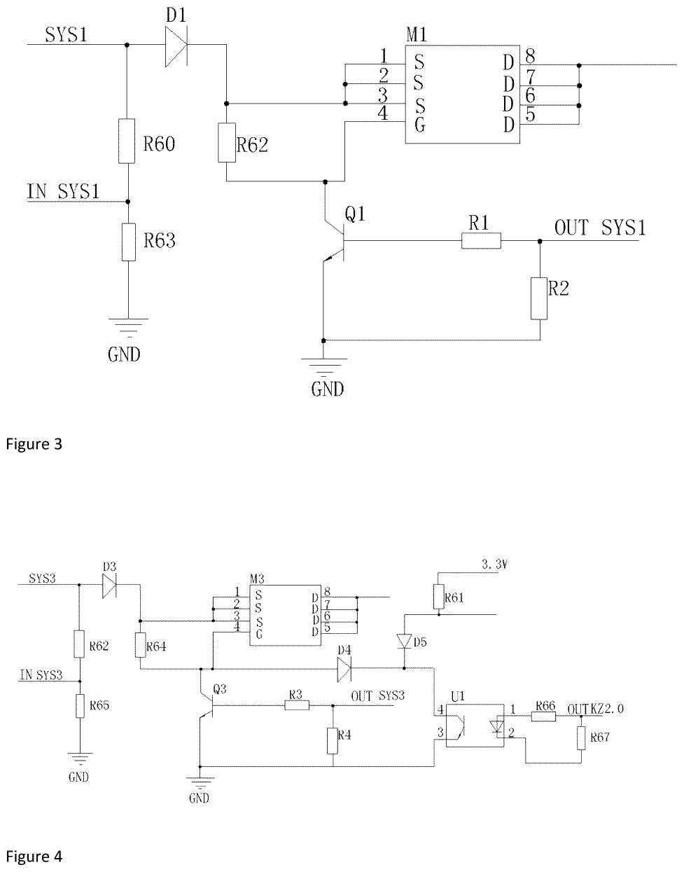

Specifically, FIG. 3 is a circuit diagram of a number one power supply circuit. The number one power supply circuit includes a direct-current 12V power supply, a field effect transistor M1, a first single-chip microcomputer, and a triode Q1. An output end of the direct-current 12V power supply is connected to a drain D of the field effect transistor M1, and a source S of the field effect transistor M1 is connected to a resistor R62 and a diode D1. The source S of the field effect transistor M1 is connected to a cathode of the diode D1, and an anode of the diode D1 is connected to a resistor R60. The resistor R60 is connected to a resistor R63. The other end of the resistor R63 is grounded. The other end of the resistor R62 is connected to a collector of the triode Q1 and a gate G of the field effect transistor M1. A base of the triode Q1 is connected to a resistor R1, and the other end of the resistor R1 is connected to a resistor R2. The other end of the resistor R2 and an emitter of the triode Q1 are connected and jointly grounded. An SYS1 signal input end of the first single-chip microcomputer is connected to the anode of the diode D1, and the resistor R60. An IN SYS1 input end of the first single-chip microcomputer is connected to the resistor R60 and the resistor R63, and an OUT SYS1 output end of the first single-chip microcomputer is connected to the resistor R1 and the resistor R2. A control signal output end of the first single-chip microcomputer is correspondingly connected to any one or a combination of more of the temperature control circuit, the pressure control circuit, the signal acquisition circuit, the communication circuit, the heating wire, the air extracting pump, the solenoid valve and the proportional solenoid valve in the gas chromatograph.

Specifically, FIG. 4 is a circuit diagram of a number three power supply circuit. The number three power supply circuit includes a direct-current 12V power supply, a direct-current 3.3V power supply, a field effect transistor M3, a third single-chip microcomputer, a triode Q3, and a photocoupler U1. An output end of the direct-current 12V power supply is connected to a drain D of the field effect transistor M3, and a source S of the field effect transistor M3 is connected to a resistor R64 and a diode D3. The source S of the field effect transistor M1 is connected to a cathode of the diode D3, and an anode of the diode D3 is connected to a resistor R62. The resistor R62 is connected to a resistor R65. The other end of the resistor R65 is grounded. The other end of the resistor R64 is connected to a collector of the triode Q3 and a gate G of the field effect transistor M3. The other end of the resistor R64 is further connected to a reverse voltage pick-off diode D4, and the resistor R64 is connected to an anode of the reverse voltage pick-off diode D4. A base of the triode Q3 is connected to a resistor R3, and the other end of the resistor R3 is connected to a resistor R4. The other end of the resistor R4 and an emitter of the triode Q3 are connected and jointly grounded. The direct-current 3.3V power supply is connected to a resistor R61, and the resistor R61 is connected to a diode D5. The resistor R61 is connected to an anode of the diode D5, and a cathode of the diode D5 is connected to a cathode of the reverse voltage pick-off diode D4 and a pin 4 of the photocoupler U1. A pin 3 of the photocoupler U1 is connected to the resistor R4 and the emitter of the triode Q3. A pin 1 and a pin 2 of the photocoupler U1 are respectively connected to a resistor R66 and a resistor R67. An SYS3 signal input end of the third single-chip microcomputer is connected to the anode of the diode D3, and the resistor R62. An IN SYS3 input end of the third single-chip microcomputer is connected to the resistor R62 and the resistor R65, and an OUT SYS3 output end of the third single-chip microcomputer is connected to the resistor R3 and the resistor R4. An OUT KZ2.0 output end of the third single-chip microcomputer is connected to the resistor R66 and the resistor R67. A control signal output end of the third single-chip microcomputer is correspondingly connected to any one or a combination of more of the temperature control circuit, the pressure control circuit, the signal acquisition circuit, the communication circuit, the heating wire, the air extracting pump, the solenoid valve and the proportional solenoid valve in the gas chromatograph.

Specifically, the number two power supply circuit has the same circuit structure as the number one power supply circuit; and the first single-chip microcomputer used in the number one power supply circuit, a single-chip microcomputer used in the number two power supply circuit and the third single-chip microcomputer used in the number three power supply circuit are of the same model.

Specifically, each power supply in the multi-circuit power supply mode is a battery pack, and the voltage of each battery pack is DC3V-DC18V. Each battery pack is composed of batteries in series or in parallel, and the number of batteries of each battery pack is greater than or equal to 2.

According to the present disclosure, by means of performing improvement design on the power supply method for the temperature control circuit, the pressure control circuit, the signal acquisition circuit, the communication circuit, the heating wire, the air extracting pump, the solenoid valve and the proportional solenoid valve in the gas chromatograph, the intrinsically-safe requirement is met, the safety problem when the gas chromatograph is used in explosion-hazardous places is solved, the application of an intrinsically-safe explosion-proof gas chromatograph power supply mode meeting the GB3836 explosion-proof standard is realized, such that the method may be applied to daily monitoring and emergency rescue in environments with explosive hazards such as oil exploitation, chemical production, underground coal mines, and tunnels.

It is understandable that, the above specific description of the present disclosure is only used to illustrate the present disclosure and is not limited by the technical solutions described in the embodiments of the present disclosure. It should be understood by a person having ordinary skill in the art that, modifications or equivalent replacements can still be made to the present disclosure, so as to achieve the same technical effect, and are all within the scope of protection of the present disclosure, as long as the needs of use are met.

1. A power supply method for an intrinsically-safe gas chromatograph, specifically comprising: converting an original single-circuit power supply mode in a gas chromatograph into a multi-circuit power supply mode, so as to respectively supply power for a temperature control circuit, a pressure control circuit, a signal acquisition circuit, a communication circuit, a heating wire, an air extracting pump, a solenoid valve and a proportional solenoid valve in the gas chromatograph, wherein power supplies in the multi-circuit power supply mode of the gas chromatograph are all independent power supplies, and are not associated with each other; the number of the power supplies of the multi-circuit power supply mode is greater than or equal to 2; each power supply in the multi-circuit power supply mode is a direct-current power supply, and the voltage of each direct-current power supply is DC5V-DC36V; the temperature control circuit, the pressure control circuit, the signal acquisition circuit, the communication circuit, the heating wire, the air extracting pump, the solenoid valve and the proportional solenoid valve in the gas chromatograph are combined in different modes, and are correspondingly powered by a plurality of power supply circuits; and an output current of the independent power supply is less than or equal to 3 A.

2. The power supply method for an intrinsically-safe gas chromatograph according to claim 1, wherein there are 3 power supply circuits of the multi-circuit power supply mode, respectively being a number one power supply circuit, a number two power supply circuit and a number three power supply circuit; the number one power supply circuit, the number two power supply circuit and the number three power supply circuit correspondingly supply power for the temperature control circuit, the pressure control circuit, the signal acquisition circuit, the communication circuit, the heating wire, the air extracting pump, the solenoid valve and the proportional solenoid valve in the gas chromatograph, which are combined in different modes; and the temperature control circuit, the pressure control circuit, the signal acquisition circuit, the communication circuit, the heating wire, the air extracting pump, the solenoid valve and the proportional solenoid valve in the gas chromatograph are combined in parallel or in series in different modes.

3. The power supply method for an intrinsically-safe gas chromatograph according to claim 2, wherein the number one power supply circuit is connected to the temperature control circuit, the pressure control circuit and the signal acquisition circuit, and supplies power for the temperature control circuit, the pressure control circuit and the signal acquisition circuit; the number two power supply circuit is connected to the communication circuit, the proportional solenoid valve, the air extracting pump and the solenoid valve, and supplies power for the communication circuit, the proportional solenoid valve, the air extracting pump and the solenoid valve; and the number three power supply circuit is connected to the heating wire, and supplies power for the heating wire.

4. The power supply method for an intrinsically-safe gas chromatograph according to claim 2, wherein alternatively, the number one power supply circuit is connected to the temperature control circuit, the pressure control circuit and the proportional solenoid valve, and supplies power for the temperature control circuit, the pressure control circuit and the proportional solenoid valve; the number two power supply circuit is connected to the communication circuit, the air extracting pump and the signal acquisition circuit, and supplies power for the communication circuit, the air extracting pump and the signal acquisition circuit; and the number three power supply circuit is connected to the heating wire and the solenoid valve, and supplies power for the heating wire and the solenoid valve.

5. The power supply method for an intrinsically-safe gas chromatograph according to claim 2, wherein the number one power supply circuit comprises a direct-current 12V power supply, a field effect transistor M1, a first single-chip microcomputer, and a triode Q1; an output end of the direct-current 12V power supply is connected to a drain D of the field effect transistor M1, and a source S of the field effect transistor M1 is connected to a resistor R62 and a diode D1; the source S of the field effect transistor M1 is connected to a cathode of the diode D1, and an anode of the diode D1 is connected to a resistor R60; the resistor R60 is connected to a resistor R63; the other end of the resistor R63 is grounded; the other end of the resistor R62 is connected to a collector of the triode Q1 and a gate G of the field effect transistor M1; a base of the triode Q1 is connected to a resistor R1, and the other end of the resistor R1 is connected to a resistor R2; the other end of the resistor R2 and an emitter of the triode Q1 are connected and jointly grounded; an SYS1 signal input end of the first single-chip microcomputer is connected to the anode of the diode D1, and the resistor R60; an IN SYS1 input end of the first single-chip microcomputer is connected to the resistor R60 and the resistor R63, and an OUT SYS1 output end of the first single-chip microcomputer is connected to the resistor R1 and the resistor R2; and a control signal output end of the first single-chip microcomputer is correspondingly connected to any one or a combination of more of the temperature control circuit, the pressure control circuit, the signal acquisition circuit, the communication circuit, the heating wire, the air extracting pump, the solenoid valve and the proportional solenoid valve in the gas chromatograph.

6. The power supply method for an intrinsically-safe gas chromatograph according to claim 2, wherein the number two power supply circuit has the same circuit structure as the number one power supply circuit.

7. The power supply method for an intrinsically-safe gas chromatograph according to claim 2, wherein the number three power supply circuit comprises a direct-current 12V power supply, a direct-current 3.3V power supply, a field effect transistor M3, a third single-chip microcomputer, a triode Q3, and a photocoupler U1; an output end of the direct-current 12V power supply is connected to a drain D of the field effect transistor M3, and a source S of the field effect transistor M3 is connected to a resistor R64 and a diode D3; the source S of the field effect transistor M1 is connected to a cathode of the diode D3, and an anode of the diode D3 is connected to a resistor R62; the resistor R62 is connected to a resistor R65; the other end of the resistor R65 is grounded; the other end of the resistor R64 is connected to a collector of the triode Q3 and a gate G of the field effect transistor M3; the other end of the resistor R64 is further connected to a reverse voltage pick-off diode D4, and the resistor R64 is connected to an anode of the reverse voltage pick-off diode D4; a base of the triode Q3 is connected to a resistor R3, and the other end of the resistor R3 is connected to a resistor R4; the other end of the resistor R4 and an emitter of the triode Q3 are connected and jointly grounded; the direct-current 3.3V power supply is connected to a resistor R61, and the resistor R61 is connected to a diode D5; the resistor R61 is connected to an anode of the diode D5, and a cathode of the diode D5 is connected to a cathode of the reverse voltage pick-off diode D4 and a pin 4 of the photocoupler U1; a pin 3 of the photocoupler U1 is connected to the resistor R4 and the emitter of the triode Q3; a pin 1 and a pin 2 of the photocoupler U1 are respectively connected to a resistor R66 and a resistor R67; an SYS3 signal input end of the third single-chip microcomputer is connected to the anode of the diode D3, and the resistor R62; an IN SYS3 input end of the third single-chip microcomputer is connected to the resistor R62 and the resistor R65, and an OUT SYS3 output end of the third single-chip microcomputer is connected to the resistor R3 and the resistor R4; an OUT KZ2.0 output end of the third single-chip microcomputer is connected to the resistor R66 and the resistor R67; and a control signal output end of the third single-chip microcomputer is correspondingly connected to any one or a combination of more of the temperature control circuit, the pressure control circuit, the signal acquisition circuit, the communication circuit, the heating wire, the air extracting pump, the solenoid valve and the proportional solenoid valve in the gas chromatograph.

8. The power supply method for an intrinsically-safe gas chromatograph according to claim 1, wherein each power supply in the multi-circuit power supply mode is a battery pack, and the voltage of each battery pack is DC3V-DC18V; and each battery pack is composed of batteries in series or in parallel, and the number of batteries of each battery pack is greater than or equal to 2.
